(19) United States
(12) Patent Application Publication
(10) Pub. No.: US 2023/0176643 A1
(43) Pub. Date: Jun. 8, 2023

(54) TOUCH BASED COMPUTING DEVICES

(71) Applicant: HEWLETT-PACKARD DEVELOPMENT COMPANY, L.P., SPRING, TX (US)

(72) Inventors: SHIHHENG CHEN, TAIPEI CITY (TW); WANCHIEH LU, TAIPEI CITY (TW); WEIHUNG LIN, TAIPEI CITY (TW); HSIAOYING TSAI, TAIPEI CITY (TW)

(73) Assignee: HEWLETT-PACKARD DEVELOPMENT COMPANY, L.P., SPRING, TX (US)

(21) Appl. No.: 17/997,954

(22) PCT Filed: Jun. 23, 2020
(86) PCT No.: PCT/US2020/039073

§ 371 Date: Nov. 4, 2022

(51) Int. Cl. G06F 1/3234; G06F 1/3231; G06F 1/16; G06F 3/0346; G06F 3/0354; G06F 21/32

(52) U.S. Cl. CPC G06F 1/3234; G06F 1/3231; G06F 1/1616; G06F 3/0346; G06F 3/03547; G06F 21/32

(57) ABSTRACT

Examples of a computing device capable of switching between a low-power state and an operational state, are described. In one example, the computing device comprises a touch sensor, provided on an outer surface of a housing of the computing device. In response to a determination by the physical sensor that the computing device is in a container, the computing device may switch from an operational state to a low-power state. In another example, in response to detecting a touch by the touch sensor and a change in the physical attribute, the computing device may switch from the low-power state to the operational state.

### BACKGROUND

Computing devices, when operational, may be used intermittently. While the computing device is not in use, it may switch from an operational state to a low-power state for conserving power. Examples of such low-power state include, but are not limited to, the different power states as defined in Advanced Configuration and Power Interface (ACPI). The computing device may then be ‘woken up’ or switched back to the operational state when a triggering input is detected. For example, a manual input provided through a peripheral device, such as a click of a mouse, pressing of a key on a keyboard, or opening of a lid of a laptop, may switch the computing device from any one of the low-power states to the operational state.

### BRIEF DESCRIPTION OF DRAWINGS

The following detailed description references the drawings, wherein:

FIG. 1 is a block diagram of an example computing device, as per an example of the present subject matter;

FIG. 2 is a block diagram of an example electronic, as per another example of the present subject matter;

FIG. 3 is a detailed block diagram of an example computing device, as per an example of the present subject matter;

FIG. 4 is a flowchart of an example method to be implemented in a computing device, as per an example of the present subject matter; and

FIG. 5 illustrates a non-transitory computer-readable medium for causing the computing device to switch between an operational state and a low-power state, as per an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

Computing devices may alternate between an operational state and a low-power state depending on whether they are in use or not. While the computing device is in an operational state, all functionalities and features of the computing device may be available. However, in some cases the computing device may remain idle for a predetermined amount of time. In such cases, to conserve power, the computing device may switch to a low-power state, after a predetermined time duration has passed since the last user activity. As the computing device enters a low-power state, a set of functionalities of the computing device may be suspended.

As such, a number of power states may be prescribed in which the computing device may persist depending on how long the computing device stays idle. Examples of such states include, but are not limited to, power states as defined in Advanced Configuration and Power Interface (ACPI) specification, which include S0, S1, S2, S3, S4, and S5. S0 is the state in which the device is fully operational, with the processor executing programmed instructions. In successive states, referred to as the low-power state, various functionalities of the computing device may reduce, or various parts of the computing device may power down. For example, in S1 state the processor may stop processing instructions, but the power to the processor and the memory may still be maintained. S2 or S3 involves the processor being powered off, with computing device state, data, or context being saved onto the RAM. During S4 and S5, the computing device may completely power down. During S4 (i.e., when the computing device enters a hibernate state), contents of the main memory of the computing device may be retained in the disk storage as the computing device is powered down. During the hibernate state, power consumption is reduced to the lowest levels prescribed for the computing device. During S5 (i.e., power-off state), the computing device is fully shut down.

If the computing device is to resume operation, a manual trigger in the form of a mouse click, opening of lid of a laptop, and such may be provided. On receiving the manual trigger, the computing device may initiate switching to the operational state. Depending on which state the computing device is switching from, the time taken to resume operation may vary. For example, the computing device may take less time to resume from a sleep state (i.e., S1-S2), as compared to resuming operation from the S3-S4 states. In any case, the user may have to provide the manual trigger and wait for some time before the device may be returned to its operational state.

In certain cases, the user may not manually switch the computing device to a low-powered state. For example, in case of a laptop, the user may simply close the lid and place the computing device in a bag or a similar container. The container may be flexible or may be rigid in shape. The computing device may switch to a low-powered state after a time interval has elapsed. As a result, the computing device may still be utilizing stored power from the battery despite not being used. This may reduce the overall power which may be available for the computing device, when the computing device returns to the operational state.

Actions such as closing a lid may not be available for types of computing devices, such as a mobile phone, a hand-held computing device, or a tablet computer. In such cases, the user may simply place the hand-held portable computing device in a container, such as a bag, and the computing device may only switch to a low-power state after a time period has elapsed since the most recent user input was received. During such time, an amount of electrical power from the battery may still be utilized. This too may impact the overall power which may be available when the computing device is switched to the operational state.

Furthermore, when the user wishes to retrieve the computing device from the container, the user may have to manually provide a triggering input for the computing device to resume operation. The process of switching the states of the computing device may commence, when the entire process of providing a triggering input or manually initiating the booting-up process has been completed. This may take time since the user may assume a seating position before the computing device may be retrieved, appropriately positioned for use, and then provide a manual trigger to enable the computing device to return to the operational state. This may introduce inordinate waiting times for the user.

Approaches for controlling the switching of computing device between a low-power state and an operational state, are described. The computing device comprises a physical sensor and a touch sensor. The physical sensor may be implemented and coupled to a control circuitry of the computing device, whereas the touch sensor is provided on an outer surface of a housing of the computing device. In one example, the physical sensor may monitor a physical attribute of the computing device, to identify when a user is securing the computing device in a container. Examples of a physical attribute may include, but is not limited to, motion, orientation, or ambient light. In an example, the physical sensor may monitor a physical attribute or a combination of other types physical attributes, without deviating from the scope of the present subject matter. Based on monitoring by the physical sensor, the controller may determine whether the computing device is present in the container.

On determining the computing device to be present in the container, the controller may then cause the computing device to switch from an operational state to a low-power state. In an example, the low-power state may be one of a sleep state, a hibernate state, or a powered-down state.

In another example, when the computing device is in the low-power state and present in the container, the touch sensor provided may monitor whether the computing device has been touched by the user, and whether a physical attribute of the computing device undergo a change, subsequent to the detection of the touch. On detecting the touch, the touch sensor may generate a sensed signal. Based on the sensed signal provided by the touch sensor, the controller may determine a type of touch gesture corresponding to the detected touch. The controller may further determine whether the type of touch gesture corresponds to the user gripping the computing device. Thereafter, the controller may also detect a change in the physical attribute of the computing device. In response to the user's touch and the change in the physical attribute, the controller may then cause the computing device to switch from the low-power state to the operational state.

In yet another example, the touch sensor, in response to detecting a touch by the user, may further obtain a fingerprint impression produced as a result of the detected touch. Thereafter, the obtained fingerprint impression may be authenticated to determine whether the user providing the touch input is an authorized user.

The approaches described in the present subject matter may enable detecting when the computing device is placed in the container, and accordingly switch the computing device to a low-power state to conserve the power levels of the computing device. Further, the present approaches also enable detection of a touch from a user, for example, when removing the computing device from the container, and accordingly initiate the switching of the computing device from the low-power state to the operational state. In this manner, by the time the computing device is positioned for use by the user, it will have resumed to its operational state. This avoids instances where the user has to wait before the computing device may return to the operational state.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

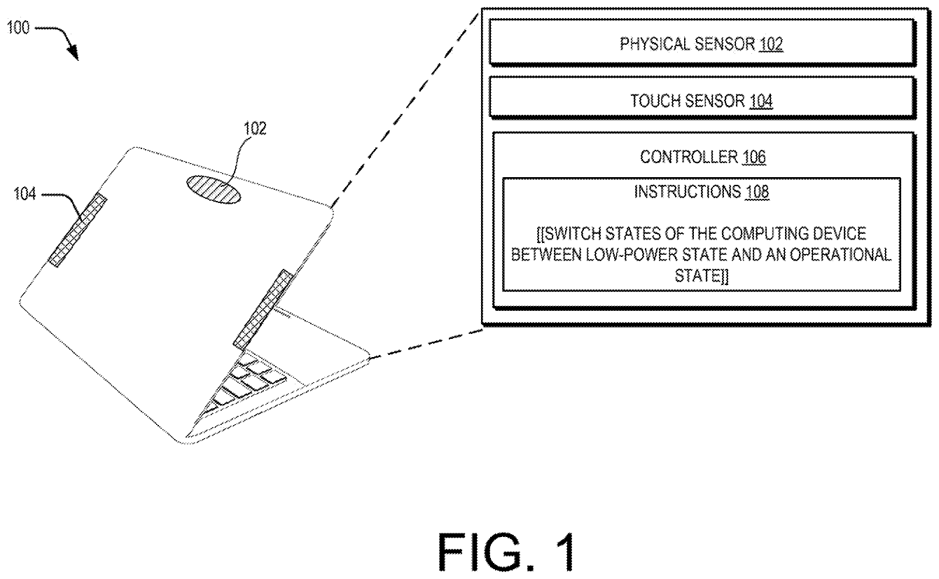

The manner in which the example communication devices are implemented are explained in detail with respect to FIGS. 1-5. While aspects of described communication device may be implemented in any number of different electronic devices, environments, and/or implementations, the examples are described in the context of the following example device(s). It is to be noted that drawings of the present subject matter shown here are for illustrative purposes and are not to be construed as limiting the scope of the subject matter claimed.

FIG. 1 illustrates a block diagram of a computing device 100, as per an implementation of the present subject matter. Examples of computing device 100 may include, but are not limited to, a portable notebook PC, a mobile device, and a hand-held computing device. The computing device may further include a physical sensor 102 and a touch sensor 104. In an example, the physical sensor 102 may be coupled to the internal circuity of the computing device 100. The touch sensor 104 may be provided on an outer surface of a housing of the computing device 100. Both the physical sensor 102 and the touch sensor 104, may either include a single sensor or may be implemented as a combination of multiple sensors. In an example, the physical sensor 102 may be an accelerometer, a gyroscope, an ambient light sensor, a location-based sensor, or an integrated sensor module capable of performing the aforesaid functions. The touch sensor 104 may be a capacitive touch sensor, a resistive touch sensor, or a combination thereof. Other example sensors may also be utilized without limiting the scope of the present subject matter.

The computing device 100 may further include a controller 106. The controller 106 may be a microprocessor, microcomputer, microcontroller, digital signal processor, central processing unit, state machine, logic circuitry, and/or any device that may manipulate signals based on certain operational instructions. Among other functions. the controller 106 may fetch and execute the computer-readable instructions 108 stored in a memory (not depicted in FIG. 1), to switch the state of the computing device 100 between an operational state and a low-power state. The controller 106 may perform a series of functions in response to execution of executable instructions 108 provided in the computing device 100. In another example, the controller 106 may manage power utilization or other functions of the computing device 100 during operation.

The physical sensor 102 may monitor a physical attribute of the computing device 100, to determine whether the computing device is placed within a container. Examples of the physical attribute may include, but is not limited to, motion, orientation, or other physical attributes, such as ambient light in an immediate vicinity of the computing device 100. Based on the monitoring of the physical attribute of the computing device by the physical sensor 102, the controller 106 may determine whether the computing device 100 has been placed in the container. For example, the controller 106 may compare the sensor data from the physical sensor, with reference data. The reference data may correspond to data generated by sensors corresponding to movements, orientation, and other physical attributes of the computing device 100. Based on the comparison, the controller 106 may determine whether the computing device 100 is present in a container.

On determining the computing device 100 to be present in the container, the instructions 108 of the controller 106 may cause the computing device 100 to switch from an operational state to a low-power state in which power consumption is minimal. In an example, the low-power state may include one of S1-S3 states as defined in the ACPI specification. On the other hand, the power-down state may include a hibernate state or a power-off state.

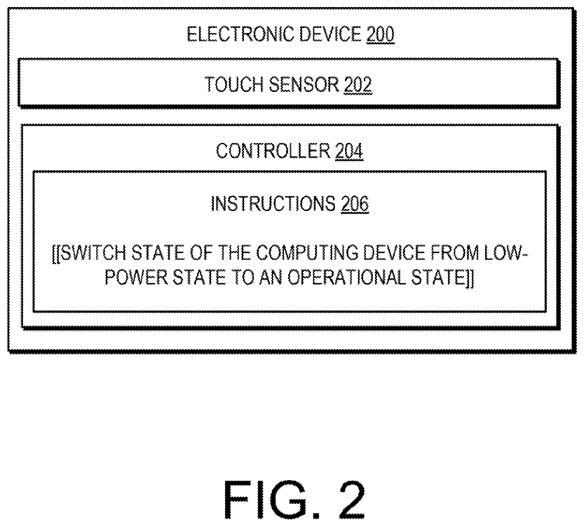

In another example, the instructions 108 may cause the computing device 100 to switch from the low-power state to the operational state, in response to the computing device 100 being retrieved from the container. In such a case, the touch sensor 104 may monitor any physical touch by the user, that may occur. In response to the detected touch by the user, the physical sensor 102 may be activated to monitor a change in the physical attribute of the computing device 100. A change in the physical attribute may correspond result from movements which the computing device 100 may undergo while being retrieved from the container. On determining that the computing device 100 is being retrieved from the container, the controller 106 may switch the computing device 100, from the low-power state to the operational state. These and other aspects are further described in conjunction with FIG. 2.

FIG. 2 illustrates a block diagram of an electronic device 200, as per an implementation of the present subject matter. The electronic device 200 may switch from a low-power state to an operational state, when a user retrieves the electronic device 200 from a storage enclosure or a container. Examples of such a container include, but are not limited to, a laptop bag, backpacks, and laptop sleeves. Other types of containers may also be used without deviating from the scope of the present subject matter.

The electronic device 200 further includes a touch sensor 202. The touch sensor 202 may be provided on an outer surface of a housing of the electronic device 200. For example, in case of a laptop, the touch sensor 202 may be provided on the lid of the laptop, on the bottom surface of the laptop, or a combination thereof. The touch sensor 202 may be implemented as a single sensor, or as a plurality of sensors located at various locations on the outer surface of the electronic device 200. In one example, the touch sensor 202 may be implemented in similar ways, as discussed for touch sensor 104. In another example, the touch sensor 202 may be biometric sensor to read and capture a fingerprint impression of the user, who may touch the electronic device 200.

Returning to the present example, the electronic device 200 may further include a controller 204, which may be similar to the controller 106. Among other functions, the controller 204 may fetch and execute the computer-readable instructions 206 stored in a memory (not depicted in FIG. 2), to enable the electronic device 200 to switch from the low-power state to an operational state. The controller 204 may perform a series of functions in response to execution of executable instructions 206 provided within the electronic device 200.

The electronic device 200 may be stowed in a container and may be in a low-power state. In an example, the low-power state may include one of a sleep state, an electronic hibernation state or a power-off state. While in the low-power state, few components, such as the touch sensor 202 may be active. In an example, the instructions 206 may cause the touch sensor 202 to monitor whether the surface of the electronic device 200 has been touched by a user. When a touch is registered, the touch sensor 202 may generate sensed signal which may be transmitted to the controller 204. The instructions 206 may cause the controller 204 to, on receiving the sensed signal, determine a type of touch gesture corresponding to the detected touch. Examples of such touch gestures may include, but are not limited to, gripping action by the user when retrieving the electronic device 200, or any action which may involve touching an upper surface and a bottom surface of the computing device 200.

Once the type of gesture is determined, the controller 204 may further detect a change in the physical attribute of the electronic device 200. Based on changes in the physical attribute, the controller 204 may ascertain that the electronic device 200 is being retrieved from the container.

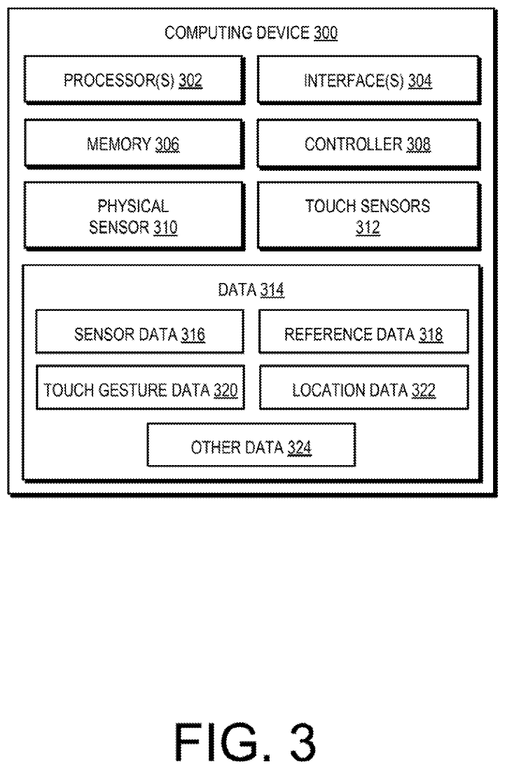

In this manner, the controller 204, in conjunction with touch sensor 202 and the physical attribute may determine whether the electronic device 200 is being retrieved by the user from the container. On determining the electronic device 200 to have been retrieved from the container, the controller 204 may then cause the electronic device 200 to switch from the low-power state to the operational state. In this manner, by the time the electronic device 200 is positioned for use by the user, it will have resumed to its operational state. The present examples avoid instances where the user has to provide a manual trigger and then wait, before the electronic device may return to the operational state. These and other aspects are explained in further details in conjunction with FIG. 3.

FIG. 3 illustrates a detailed block diagram of a computing device 300, capable of switching between a low-power state and an operational state, as per an implementation of the present subject matter. Examples of such computing devices may include, but are not limited to, a notebook PC, a mobile device, a hand-held device, or any portable computer. The computing device 300 may include a processor(s) 302, an interface(s) 304, a memory 306, a controller 308, a physical sensor 310 and a touch sensor(s) 312.

The processor(s) 302 may be implemented as microprocessors, microcomputers, microcontrollers, digital signal processors, central processing units, state machines, logic circuitries, and/or any devices that manipulate signals based on operational instructions. Among other capabilities, the processor(s) 302 is configured to fetch and execute computer-readable instructions stored in a memory 306 to switch the operational state of the computing device 300, based on certain device motion and orientation, and in response to a touch from a user.

The interface(s) 304 may include a variety of interfaces, for example, interface for data input and output devices, referred to as I/O devices, storage devices, network devices, and the like, for communicatively associating the computing device 300 with another device. The interface(s) 304 may enable intercommunication between different logical as well as hardware components which may be present within the computing device 300. In an example, the interface(s) 306 may also enable coupling of the controller 308 with the sensors 310, 312.

The memory 306 may be a computer-readable medium, examples of which include volatile memory (e.g., RAM), and/or non-volatile, memory (e.g., EPROM, flash memory, etc.). The memory 306 may be an external memory, or internal memory, such as a flash drive, a compact disk drive, an external hard disk drive, or the like. The memory 306 may further include data which either may be utilized or generated during the operation of the computing device 300.

The controller 308 may perform switching of the operational state of the computing device 300. In an example, the controller 308 may be implemented as hardware, programmable instructions, or a combination thereof. For example, the programming for the controller 308 may be executable instructions. Such instructions may be stored on a non-transitory machine-readable storage medium which may be coupled either directly with the computing device 300 or indirectly (for example, through networked means). In an example, the controller 308 may include a processing resource, which may be similar to the processor(s) 302, as either a single processor or a combination of multiple processors, to execute such instructions. In the present examples, the non-transitory machine-readable storage medium may store instructions that, when executed by the processing resource, implement controller 308. In other examples, the controller 308 may be implemented as electronic circuitry.

The computing device 300 may further include a physical sensor 310 and touch sensors 312. The physical sensor 310 may be implemented as a single sensor, or a combination of multiple sensors. In one example, the physical sensor 310 may be an accelerometer, a gyroscope sensor, an ambient light sensor, a proximity sensor, a location-based sensor, temperature sensor, or combination thereof. The physical sensor 310 is to monitor a physical attribute, such as motion, and orientation, of the computing device 300. In addition to the motion and orientation, the physical sensor 310 may also monitor any other physical attribute, such as ambient light, ambient temperature, a detected location, or a combination of different physical attributes. As may be understood, the value of the physical attribute may change when the computing device 300 is stowed in the container as compared to instances when the computing device 300 is not in the container.

The touch sensors 312 may detect a physical contact or touch by a user, on a surface of the computing device 300. In one example, the touch sensors 312 may be provided on an outer surface of a housing of the computing device 300, and may be a capacitive, or a resistive touch sensor. The touch sensors 312 may either be located at a single specific location or at multiple locations on the outer surface of the computing device 300. In an example, the touch sensors 312 may further be adapted to detect and receive a biometric input from a user. The biometric input may be detected at the instant a physical contact is made by the user.

The computing device 300 may further include data 314. The data further includes sensor data 316, reference data 318, touch gesture data 320, location data 322 and other data 324. Further, the other data 324, amongst other things, may serve as a repository for storing data that is processed, or received, or generated as a result of the execution of controller 308.

While functioning in the operational state, the physical sensor 310 may periodically monitor changes in the physical attribute of the computing device 300. The physical attribute may change when the computing device 300 traverses through the physical space while being placed in the container. For example, while in use, the computing device 300 may be placed on a flat horizontal surface, whereas while stowing the computing device 300 into the container, the orientation of the computing device 300 may change to a vertical orientation. In such cases, the physical sensor 310 may generate sensor data 316 in response to the motion or change in orientation of the computing device 300. In an example, the controller 308 may compare the sensor data 316 with reference data 318, to determine that the computing device 300 is in the process of being placed into the container. The reference data 318 may include data corresponding to example motions which the computing device 300 may undergo, or example orientations in which the computing device 300 may be positioned when placed within the container.

The physical sensor 310 may also sense and monitor other types of physical attributes, such as ambient light. For example, when the computing device 300 is placed within the container, the ambient light which the computing device 300 receives is likely to reduce. In an example, the physical sensor 310 may monitor changes in the ambient light levels of the computing device 300. Based on the changes in the ambient light levels around the computing device 300, the controller 308 may determine that the computing device 300 has been placed inside the container. In an example, the controller 308 may consider the motion and the changes in the orientation of the computing device 300, along with changes in physical attributes (such as ambient light), to determine that the computing device 300 has been placed within the container.

On determining the computing device 300 to be placed within the container, the controller 308 may generate one or more control signals to switch the computing device 300 from the operational state to a low-power state. The generated control signals may be communicated to the processor(s) 302, which may then initiate the switching of the computing device 300 to a low-power state. In one example, low-power state may include any state in which the power consumption of the computing device 300 is less than the power consumption while the computing device 300 is operating in the operational state. The low-power state may include a sleep state, i.e., the S1 to S3 state as defined under the ACPI Specification or may include a hibernate or a powered-down state, during which the power consumption is minimal.

While the computing device 300 is placed within the container, the touch sensors 312 may continue to be active, and may monitor to check for any physical contact through touch, by the user. The touch sensors 312 may be provided at various positions across the outer surfaces of the computing device 300. In an example, the touch sensors 312 may be placed at high-contact points. A high-contact point may be considered as such locations on the outer surface of the computing device which are frequently touched by the user while handling the computing device 300, such as during instances when the user is either placing the computing device 300 in, or retrieving it from, the container. Examples of such a high-contact surface include, but are not limited to, surface portions lying near edges of the computing device 300

On detecting the touch, the touch sensors 312 may generate a corresponding sensed signal. Based on the sensed signal, the controller 308 may initiate the switching of the computing device 300 from the low-power state to the operational state. It may be the case that user may have touched the computing device 300 but does not intend to retrieve the computing device 300 from the container. In such a case, the controller 308 may determine whether the computing device 300 is being retrieved, using the physical sensor 310.

In an example, the controller 308 may activate the physical sensor 310 in response to the sensed signal from the touch sensors 312. The physical sensor 310, pursuant to the detection of a touch from the user, may monitor the physical attribute of the computing device 300. In an example, the physical sensor 310 may generate corresponding sensor data, which may be stored as sensor data 316. The controller 308 may then compare the sensor data 316 thus generated, with the reference data 318. Based on the comparison, the controller 308 may determine whether the computing device 300 is being retrieved from the container or not. For example, if the sensor data 316 is such that it indicates that the computing device 300 has not undergone any change in motion, orientation or other physical attributes, the controller 308 may conclude that the computing device 300 is not being retrieved from the container. As a result, the controller 308 may not take any action, with the computing device 300 continuing to persist in the low-power state.

On the other hand, if the sensor data 316 indicates that the computing device 300 is in motion, or whether the orientation or any other physical attribute has changed, the controller 308 may generate control instructions to switch the state of the computing device 300 to the operational state from the low-power state. As mentioned previously, the reference data 318 provides information pertaining to example motions, orientations, or values of physical attributes, for instances when the computing device 300 is in the process of being positioned into the container. If the sensor data 316 corresponds to or matches the reference data 318, it may be concluded that the computing device 300 is being retrieved by the user.

On determining the computing device 300 to be retrieved, the controller 308 may generate control instructions for switching the computing device 300 to the operational state. In an example, the control instructions generated by the controller 308 may be provided to the processor(s) 302. The processor(s) 302 may, in response to the control instructions, may initiate resumption of the computing device 300 such that it may switch to the operational state. It may be noted that the initiation of the switching of the computing device 300 may commence in response to the detection of a touch by the computing device 300.

In an example, the controller 308 may only register certain types of gestures as valid touches, to reduce instances of unintentional switching of computing device 300 to the operational state. In an example, the controller 308 may determine whether the touch corresponds to a certain type of a touch gesture. For example, in order to retrieve the computing device 300, the user may grip the computing device 300, before it may be withdrawn from the container. When gripping the computing device 300, the fingers of the user are likely to come into contact with areas present near edges of an upper surface, as well as a bottom surface of the computing device 300. In an example, the touch sensors 312 positioned in such locations may register the touch. The sensor data 316 thus generated (which corresponds to touch sensors 312 registering a touch) may then be compared with touch gesture data 320. In an example, the touch gesture data 320 may be a data table indicating occurrence of a defined touch gesture (e.g., user gripping the computing device 300 with all fingers) based on which of the touch sensors 312 registered a user touch. The controller 308 may compare the sensor data 316 with the touch gesture data 320 to determine whether the computing device 300 is being gripped or not. Thereafter, the controller 308 may determine such a gesture (i.e., gripping) indicative of the computing device 300, as about to be retrieved from the container. In another example, upon receiving the sensor data 316 corresponding to the users touch, the controller 308 may register the detected touch as valid if the touch persists for a time period greater than a threshold time.

In another example, the computing device 300 may verify the identity of the user based on the physical touch by the user. In an example, the touch sensors 312 may obtain a fingerprint impression of an individual who may have touched the computing device 300. The received fingerprint impression may then be processed by the processor(s) 302 to identify different patterns that may be present within the fingerprint impression. The patterns may then be compared with stored patterns. In an example, the stored patterns may be available in other data 324. Based on the comparison between the patterns of the fingerprint impression and the stored patterns, the processor(s) 302 may verify the user as the authorized user of the computing device 300. In case the verification fails, the controller 308 may terminate the process of switching the computing device 300 from the low-power state to the operational state.

In another case, the controller 308 may determine whether the computing device 300 is at a first location. A present or detected location of the computing device may be determined by the physical sensor 310. For example, the first location may include user's working environment, such as their office. In an example, the first location may be specified by the user. In cases where the user tends to work regularly and retrieves the computing device from the container when at the first location, the controller 308 may switch the computing device 300 from the low-power state to an operational state, on detecting that the computing device 300 is being retrieved from the container. In an example, information pertaining to the first location may be stored as location data 322. The controller 308 may then compare the detected location of the computing device 300 with the location data 322 to determine whether the computing device 300 is present at the first location. However, if the user and the computing device 300 are present at another location, say their home location, the controller 308 may prevent switching of the state of the computing device 300 to the operational state.

The switching of the computing device 300 may be further performed based on additional factors, such as time of retrieving the computing device 300. The controller 308 may either prevent or permit switching of the computing device 300 on determining whether the computing device 300 is being retrieved between a first reference time and a second reference time. For example, when the computing device 300 is retrieved from the container within usual working hours of the user, the controller 308 causes the computing device 300 to switch from the low-power state to the operational state immediately, thereby reducing the time taken by computing device to resume its operation. In an example, the first reference time and a second reference time may be specified by the user, or may be determined based on user usage data.

As evident through the above examples, any computing device (e.g., the computing device 300) may be switched to low-power states from an operational state depending on the presence of the computing device in a container. The user need not manually switch off the computing device, every time before securing it in the container. Further, the computing device may be switched back to the operational state from the low-power state when the user is retrieving the computing device from the container. The computing device resumes its operation while being retrieved from the container, thereby reducing the time taken by the user in cases where the user needs to manually provide the triggering input and/or initiate the booting up process of the computing device.

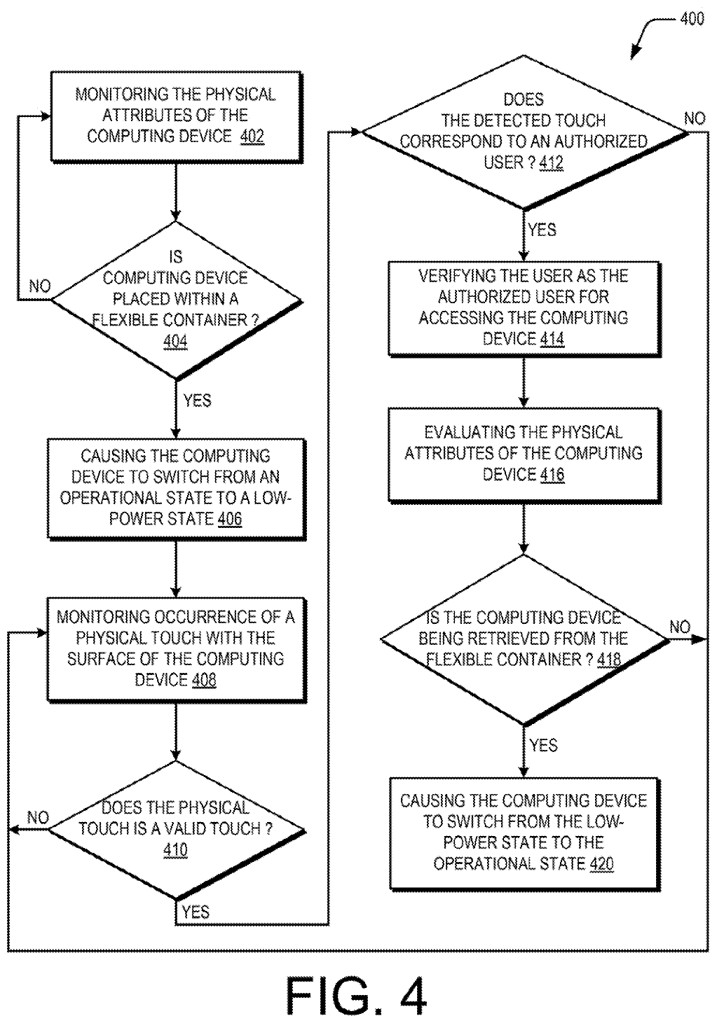

FIG. 4 illustrates a method 400 to be implemented in a computing device 300, as per an implementation of the present subject matter. Although the method 400 may be implemented for servicing of a variety of computing devices, for the ease of explanation, the present description of the example method 400 is provided in reference to the above-described computing device 300. The order in which the method 400 is described is not intended to be construed as a limitation, and any number of the described method blocks may be combined in any order to implement the method 400, or an alternative method.

The blacks of the method 400 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 402, a physical attribute of the computing device may be monitored. For example, the physical sensor 310 may periodically monitor the motion or a change in orientation of the computing device 300 while the device is in the operational state. As described previously, the computing device 300 may undergo such motion or changes in orientation, when it is picked up and stowed in a container. In response to the changes in the physical attribute, the physical sensor 310 may generate sensor data 316.

At block 404, a determination may be made to check whether the computing device has been placed within the container. For example, the controller 308 may compare the sensor data 316 with reference data 318, to determine that the computing device 300 is in the process of being placed into the container. The reference data 318 may include data corresponding to example motions which the computing device 300 may undergo, or example orientations in which the computing device 300 may be positioned when placed within the container. If the sensor data 316 does not correspond to the reference data 318, the controller 308 may determine that the computing device 300 is not being placed within the container (‘No’ path from block 404). Thereafter, the process may recursively monitor the physical attribute of the computing device 300 (as depicted in block 402). If, however, the sensor data 316 corresponds to the reference data 318, the controller 308 may conclude that the computing device 300 is in the process of being placed or stowed within the container (‘Yes’ path from block 404). Thereafter, the process proceeds to block 406.

At block 406, the computing device may be switched from an operational state to a low-power state based on determining that the computing device has been placed within the container. For example, the controller 308 on determining that the computing device 300 is present in the container, may generate one or more control instructions. The control instructions may then be executed by the processor(s) 302 to switch the computing device 300 from the operational state to a low-power state. In an example, the low-power states may correspond to power states S1-S5 as described in ACPI specification.

At block 408, occurrence of a physical touch with the surface of the computing device, may be monitored. In an example, while the computing device 300 is in the low-power state, the touch sensors 312 may continue to monitor whether any physical contact by the user occurs with any part of the surface of the computing device 300. In an example, the touch sensors 312 may be provided at high-contact points, i.e., locations on the outer surface of the computing device which are frequently touched by the user while handling the computing device 300.

At block 410, the touch may be further evaluated to check whether it is a valid touch or not. For example, in some cases, the user may touch the computing device 300 but may not intend to retrieve it from the container. In such cases, the controller 308 may assess whether the touch registered by the touch sensors 312 is valid or not. In an example, the controller 308 may determine whether the touch corresponds to a certain type of a touch gesture, such as gripping action. As may be understood, while gripping the computing device 300, the fingers of the user are likely to come into contact with areas present near edges of an upper surface, as well as a bottom surface of the computing device 300. In an example, the touch sensors 312 positioned in such locations may register the touch. The sensor data 316 thus generated (which corresponds to touch sensors 312 registering a touch) may then be compared with the touch gesture data 320 to determine whether the touch is a valid touch or not. If the sensor data 316 does not correspond to the touch gesture data 320 (‘No’ path from block 410), no further action may be taken, and the computing device 300 may continue monitoring occurrence of a physical touch (as depicted at block 408).

However, if the sensor data 316 does correspond to the touch gesture data 320 (‘Yes’ path from block 410), the process may proceed further to determine whether the user touching the computing device is the authorized user for accessing the computing device (block 412). At block 412, the controller 308 may obtain a fingerprint impression based on the contact of a finger of an individual with any one of the touch sensors 312. The received fingerprint impression may then processed by the processor(s) 302 to identify different patterns within the fingerprint impression. The processor(s) 302 may then compare the patterns in the fingerprint impression with stored patterns that may be stored in other data 324. Based on the comparison between the patterns of the fingerprint impression and the stored patterns, the processor(s) 302 may verify the user as the authorized user of the computing device 300. In case the verification fails, no further action is to be taken and the computing device 300 is not switched to the operational state (‘No’ path from block 412). However, on determining that the patterns of the obtained fingerprint impression matches the stored patterns, the individual may be verified as the authorized user (block 414). The method then may further proceed to block 416

At block 416, the physical attribute of the computing device may be evaluated. For example, the physical sensor 310, pursuant to the detection of a touch from the user, may further monitor the physical attribute, such as motion and orientation, of the computing device 300. Based on the monitoring, the physical sensor 310 may generate corresponding sensor data 316. The controller 308 may then compare the sensor data 316 thus generated, with the reference data 318. Based on the comparison, the controller 308 may determine whether the computing device 300 is undergoing a motion and change in orientation, which corresponds to the computing device 300 being retrieved from the container or not.

At block 418, a further determination may be made to ascertain whether the computing device is in the process of being retrieved from the container. For example, controller 308 may determine based on the sensor data 316 obtained from the physical sensor 310, that the computing device 300 is being retrieved from the container (‘Yes’ path from block 418). On determining that the computing device 300 is being retrieved, the controller 308 may generate control instructions which when executed switch the computing device 300 from the low-power state to the operational state (block 420). If, however, the controller 308 determines that the computing device 300 is not being retrieved from the container, no further action may be taken. The computing device 300 may continue monitoring for occurrence of a physical touch by the user (as depicted by block 408).

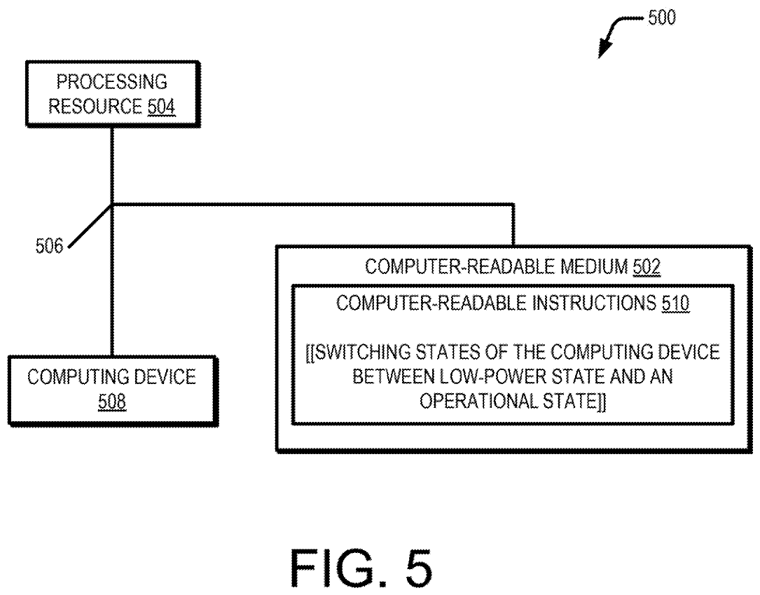

FIG. 5 illustrates a computing environment 500 implementing a non-transitory computer-readable medium 502 for causing a computing device to switch between an operational state and a low-power state, as per an implementation of the present subject matter. In an example, the computing environment 500 may comprise the above-explained computing device 300. The computing environment 500 includes a processing resource 504 communicatively coupled to the non-transitory computer-readable medium 502 through a communication link 506. In an example, the processing resource 504 may be a controller within the computing device 300 that fetches and executes computer-readable instructions from the non-transitory computer-readable medium 502.

The non-transitory computer-readable medium 502 may be, for example, an internal memory device or an external memory device. In one example, the communication link 506 may be a direct communication link, such as any memory read/write interface.

In one example, the non-transitory computer-readable medium 502 comprises executable instructions 510 for switching the computing device 300 between the low-power state and the operational state. To this end, the non-transitory computer-readable medium 502 may comprise executable instructions 510 to implement the functions performed by the controller 308. In an example, the instructions 510 when executed may cause to obtain sensor data, such as sensor data 316, from a sensor, such as physical sensor 310, provided within the computing device 300. The sensor data 316 thus obtained corresponds to electrical signals generated by the physical sensor 310 during the monitoring of the physical attribute of the computing device 300.

Once the sensor data 316 is obtained, the instructions 510 may further cause the controller 308 to process the sensor data 316 thus collected. Based on the processing, the controller 308 may determine whether the computing device 300 is present in a container. If it is determined, based on the processing of the sensor data 316, that the computing device 300 is present in a container, the instructions 510 may further cause the computing device 300 to switch from an operational state to a low-power state.

While the computing device 300 is in the low-power state, the instructions 510 may further cause the touch sensors 312 to monitor for occurrence of a touch from a user on the outer surface of the computing device, e.g., the computing device 300. On registering a touch, the touch sensors 312 may generate sensor data. The instructions 510 may further cause the sensor data to be processed whether the touch corresponds to the user gripping the computing device 300. On determining that the computing device 300 is being gripped by the user, the instructions 510 may further cause detection of a change in the physical attribute of the computing device 300. Examples of the physical attribute include, but is not limited to, motion, orientation, and ambient light. Based on the change in physical attribute of the computing device 300, the instructions 510 may further cause the computing device 300 to switch from a low-power state to an operational state.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

I/We claim:

1. A computing device comprising:
a physical sensor, wherein the physical sensor s to monitor a physical attribute of the computing device;
a touch sensor provided on an outer surface of a housing of the computing device;
a controller coupled to the physical sensor and the touch sensor, wherein the controller is to:
in response to a determination, via the physical sensor, that the computing device is in a container, cause the computing device to switch from an operational state to a low-power state; and
in response to detecting a touch by the touch sensor and a change in the physical attribute of the computing device, cause the computing device to switch from the low-power state to the operational state.

2. The computing device as claimed in claim 1, wherein the physical sensor is an accelerometer, a gyroscope sensor, an ambient light sensor, a biometric based touch sensor, or a combination thereof.

3. The computing device as claimed in claim 1, wherein the physical attribute of the computing device comprises motion of the computing device, orientation of the computing device, amount of ambient light in an immediate vicinity of the computing device, or a combination thereof.

4. The computing device as claimed in claim 1, wherein the container is a a laptop bag, a backpack, or a laptop sleeve to securely retain the computing device.

5. The computing device as claimed in claim 1, wherein the low-power state comprises a sleep state, hibernate state, or a power-off state.

6. An electronic device comprising:
a touch sensor provided on an outer surface of a housing of the electronic device; and
a controller coupled to the touch sensor, wherein the controller is to:
monitor for a sensed signal generated by the touch sensor in response to detecting a touch by a user, wherein the electronic device is in a low-power state while placed within a container;
on detecting the touch by the user, determine a type of touch gesture corresponding to the detected touch;
for a type of touch gesture, detect a change in a physical attribute of the electronic device;
ascertain whether the electronic device has been retrieved from the container storing the electronic device; and
in response to the electronic device having been retrieved from the container, cause the electronic device to switch from the low-power state to an operational state.

7. The electronic device as claimed in claim 6, further comprising a physical sensor, wherein the physical sensor is a proximity sensor, a location-based sensor, a gyroscope, an accelerometer, or a combination thereof, to detect a change in the physical attributes of the electronic device, wherein the physical attribute comprises a motion, an orientation, or an amount of ambient light in an immediate vicinity of the electronic device.

8. The electronic device as claimed in claim 6, wherein the touch sensor is to:
obtain a fingerprint impression produced as a result of the detected touch by the user; and
authenticate the user as an authorized user of the electronic device based on the fingerprint impression.

9. The electronic device as claimed in claim 6, wherein to detect the change in the orientation of the electronic device, the controller is to determine whether the orientation changes from an initial orientation to a target orientation.

10. The electronic device as claimed in claim 6, wherein the controller is to ascertain whether the electronic device has been retrieved from the container based on the presence of the electronic device at a first location, wherein the first location is evaluated based on user's historical location data.

11. The electronic device as claimed in claim 6, wherein the controller is to register the detected touch persisting for a time period greater than a threshold time, as a valid touch.

12. The electronic device as claimed in claim 6, wherein the controller is to cause the electronic device to switch from the low-power state to an operational state in response to the electronic device having been retrieved from the container between a first reference time and a second reference time.

13. A non-transitory computer-readable medium comprising computer-readable instructions, which when executed by the controller, cause a computing device to:
obtain sensor data from a physical sensor of the computing device, wherein the physical sensor is to monitor a physical attribute of the computing device;
switch the computing device from an operational state to a low-power state, on determining the computing device to be present in a container based on the sensor data;
while the computing device is in the low-power state, obtain sensor data, from a touch sensor provided on an outer surface of a housing of the computing device, generated in response to detecting a touch by a user;
process the sensor data obtained from the touch sensor, to determine occurrence of a touch gesture corresponding to the user gripping the computing device;
detect a change in the physical attribute of the computing device to ascertain whether the computing device has been retrieved from the container storing the computing device; and
cause the computing device to switch from the low-power state to the operational state.

14. The non-transitory computer-readable medium as claimed in claim 13, wherein the instructions are to cause the computing device to switch to the low-power state at a user-specified location or within a user-specified time duration.

15. The non-transitory computer-readable medium as claimed in claim 13, wherein the touch sensor is a capacitive touch sensor, a resistive touch sensor, or combination thereof.
